(19) United States
(12) Patent Application Publication
(10) Pub. No.: US 2006/0094396 A1
(43) Pub. Date: May 4, 2006

(54) Apparatus and method for connecting an emergency call

(76) Inventors: Sharada Raghuram, Buffalo Grove, IL (US); Richard C. Burbidge, Hook (GB); Rohini Polisetty, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/975,566

(22) Filed: Oct. 28, 2004

(51) Int. Cl. H04M 11/04

(52) U.S. Cl. 455/404.1; 455/403

(57) ABSTRACT

An apparatus and method for connecting an emergency call with a wireless communication device. An initial direct transfer message with an emergency cause can be sent on an existing radio resource control connection. A cell change order can be received. Alternately, a connection release message with a call redirection cause can be received. The wireless communication device can synchronize to a designated global system for mobile communications cell. The emergency call can then be established on the global system for mobile communications cell.

### CROSS-REFERENCE TO RELATED APPLICATIONS

This application is related to the application entitled “Apparatus and Method for Connecting an Emergency Call,” Motorola case number CS90109, filed on even date herewith and commonly assigned to the assignee of the present application, which is hereby incorporated by reference.

### BACKGROUND

1. Field

The present disclosure is directed to a method and apparatus for connecting an emergency call. More particularly, the present disclosure is directed to redirecting an emergency call to a global system for mobile communications system.

2. Description of Related Art

Presently, wireless communication device systems allow users to make emergency calls, such as 911 calls. Upcoming wireless communication device systems will also provide the ability to locate a user of a wireless communication device. This can allow a user to be located after placing an emergency call. Unfortunately, some Universal Mobile Telecommunications System (UMTS) networks might not support network based or user equipment based location solutions, such as Assisted Global Positioning System (AGPS). However, some Global System for Mobile communications (GSM) networks support other location methods, such as Uplink Time Difference of Arrival (UTDOA), and it may be possible to use an Inter RAT (Radio Access Technology) redirection procedure to move the wireless communication device to GSM during an emergency call establishment. Unfortunately, if the user initiates an emergency call when the wireless communication device is already in a connected mode, such as in the middle of a packet session, the wireless communication device's Radio Resource Control (RRC) entity will not send a “RRC CONNECTION REQUEST.” Instead, it will use the existing connection and send a NAS (Non Access Stratum) message “CM SERVICE REQUEST” through an Initial Direct Transfer (IDT) message. In this scenario, the network cannot move the wireless communication device to GSM using the redirection procedure. Furthermore, current procedures for moving a wireless communication device between services are not suitable for locating the wireless communication device using UTDOA during an emergency call. For example, handover from a Universal Terrestrial Radio Access Network (UTRAN) procedure is not useful as the wireless communication device does not send GSM Random Access Channel (RACH) bursts, which are required for UTDOA, after moving to GSM. Furthermore, current system specifications do not allow a Cell Change Order procedure to be used during a circuit switched call.

The present disclosure provides solutions for the above and other related problems.

### SUMMARY

An apparatus and method for connecting an emergency call with a wireless communication device. An initial direct transfer message with an emergency cause can be sent on an existing radio resource control connection. A cell change order can be received. Alternately, a connection release message with a call redirection cause can be received. The wireless communication device can synchronize to a designated global system for mobile communications cell. The emergency call can then be established on the global system for mobile communications cell.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary block diagram of a wireless communication device according to one embodiment;

FIG. 3 is an exemplary flowchart illustrating the operation of a wireless communication device according to one embodiment;

FIG. 4 is an exemplary flowchart illustrating the operation of a wireless communication device according to another embodiment;

FIG. 5 is an exemplary signal diagram illustrating signals in the system according to one embodiment; and

FIG. 6 is an exemplary signal diagram illustrating signals in the system according to another embodiment.

### DETAILED DESCRIPTION

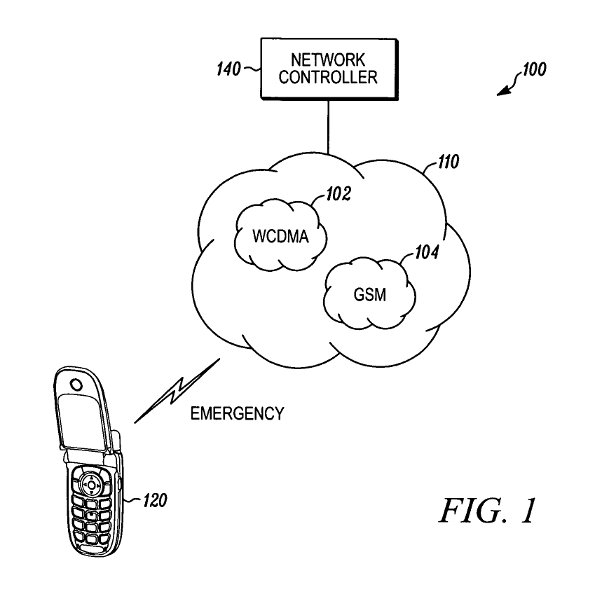

FIG. 1 is an exemplary block diagram of a system 100 according to one embodiment. The system 100 can include a network controller 140, a network 110, and at least one wireless communication device 120. The wireless communication device 120 can be a telephone, a wireless telephone, a cellular telephone, a personal digital assistant, a pager, a personal computer, a mobile communication device, or any other device that is capable of sending and receiving communication signals on a network including wireless network.

In an exemplary embodiment, the network controller 140 is connected to the network 110. The controller 140 may be located at a base station, at a radio network controller, or anywhere else on the network 110. Also, there may be multiple controllers on the network 110. The controller 140 can control operations of the network 110. The network 110 may include any type of network that is capable of sending and receiving signals, such as wireless signals. For example, the network 110 may include a wireless telecommunications network, a cellular telephone network, a frequency division duplex network, a time division duplex network, a satellite communications network, and other like communications systems. According to one embodiment, the network 110 includes a wideband code division multiple access (WCDMA) network 102 and a global system for mobile communications (GSM) network 104. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals.

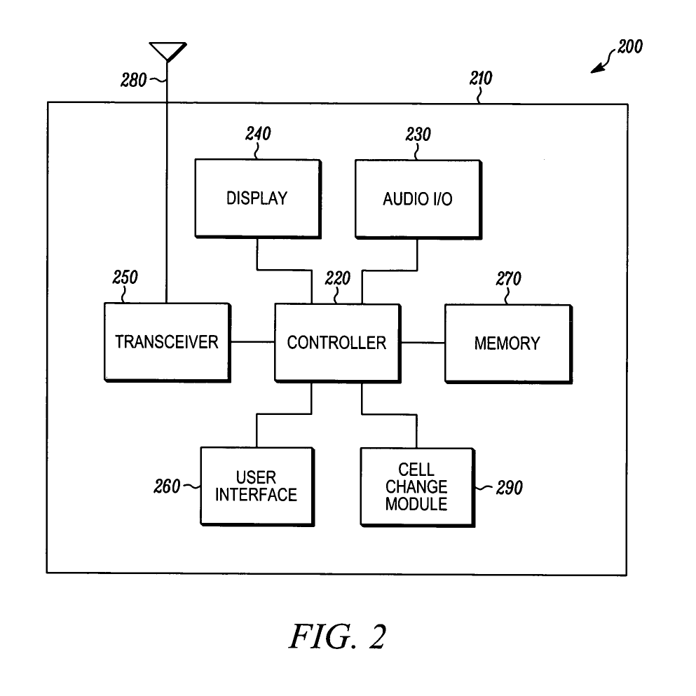

FIG. 2 is an exemplary block diagram of a wireless communication device 200, such as the wireless communication device 120, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The wireless communication device 200 can also include a cell change module 290. The cell change module 290 can be coupled to the controller 220, can reside within the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, other inputs, an additional display, or any other device useful for providing an interface between a user and a electronic device. The memory 270 may include a random access memory, a read only memory, an optical memory, a subscriber identity module memory, or any other memory that can be coupled to a wireless communication device.

In operation, the controller 220 can control the operations of the wireless communication device 200 and can operate the wireless communication device 200 on the wideband code division multiple access network 102. A user input, such as the user interface 260 or the audio input and output 230, can receive an emergency call request. The transceiver 250 can send an initial direct transfer message with an emergency cause on an existing radio resource control connection in response to the user input receiving the emergency call request. The cell change module 290 can receive a cell change order, synchronize to a designated global system for mobile communications cell, and establish an emergency call on the global system for mobile communications cell. The transceiver 250 can send the initial direct transfer message with an emergency cause on an existing radio resource control connection on the wideband code division multiple access network 102. The transceiver 250 can send a channel request with an emergency cause to a global system for mobile communications network 104 after synchronizing to the designated global system for mobile communications cell. The controller 220 can maintain the existing radio resource control connection while the cell change module 290 synchronizes to the designated global system for mobile communications cell. The cell change module 290 can synchronize to a designated global system for mobile communications cell by collecting system information and reading system information on the designated global system for mobile communications cell.

According to another embodiment, the controller 220 can control the operations of the wireless communication device 200. The user input can receive an emergency call request. The transceiver 250 can send an initial direct transfer message with an emergency cause on an existing radio resource control connection in response to the user input receiving the emergency call request. The transceiver 250 can send the initial direct transfer message on the wideband code division multiple access network 102. The cell change module 290 can receive a connection release message with a call redirection cause, synchronize to a designated global system for mobile communications cell, and establish an emergency call on the global system for mobile communications cell. The cell change module 290 can send a channel request with an emergency cause to a global system for mobile communications network 104 after synchronizing to the designated global system for mobile communications cell. The cell change module can establish the emergency call on a global system for mobile communications network 104 after sending the channel request message with the emergency cause.

The connection release message can include inter-radio access technology redirection information. The controller 220 can avoid notifying a user of the wireless communication device 200 that that a call was released by the connection release message with the call redirection cause. The cell change module 290 can synchronize to a designated global system for mobile communications cell by performing global system for mobile communications cell selection and camping on a global system for mobile communications cell. The cell change module 290 can perform global system for mobile communications cell selection by collecting system information and reading system information on a selected global system for mobile communications cell.

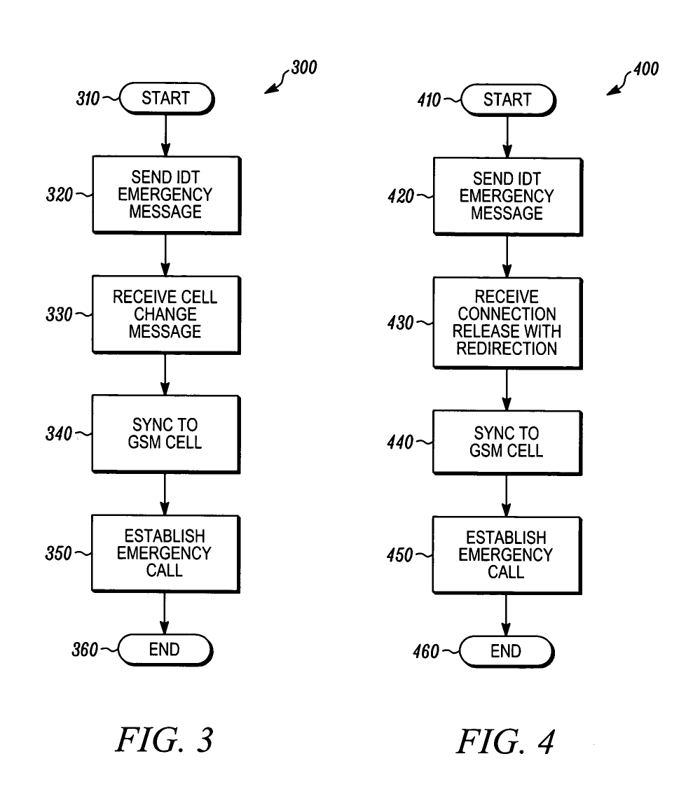

FIG. 3 is an exemplary flowchart 300 illustrating the operation of the wireless communication device 200 according to one embodiment. In step 310, the flowchart begins. For example, the wireless communication device 200 can be operating on the wideband code division multiple access network 102 and can receive a user input of an emergency call request on an input of the wireless communication device 200. In step 320, the wireless communication device 200 can send an initial direct transfer message with an emergency cause on an existing radio resource control connection. For example, the wireless communication device 200 can send an initial direct transfer message with an emergency cause on an existing radio resource control connection on the wideband code division multiple access network 102. In step 330, the wireless communication device 200 can receive a cell change order, such as a cell change message, which can include a call redirection cause. The call redirection cause can inform the wireless communication device 200 that it can attempt establishment of the call on the GSM network 104 rather than just aborting the call attempt or going into idle mode on the GSM network 104. Alternately, the cell change message does not need to include an explicit call redirection indicator. For example, the fact that the message is received while the wireless communication device 200 has a circuit switched domain connection active can be seen as an implicit call redirection indicator. In step 340, the wireless communication device 200 can synchronize to a designated global system for mobile communications cell. The wireless communication device 200 can synchronize to a designated global system for mobile communications cell by collecting system information and reading system information on the designated global system for mobile communications cell. The wireless communication device 200 can maintain the existing radio resource control connection while synchronizing to the designated global system for mobile communications cell. In step 350, the wireless communication device 200 can establish an emergency call on the global system for mobile communications cell. The wireless communication device 200 can establish an emergency call by sending a channel request with an emergency cause to the global system for mobile communications network 104. In step 350, the flowchart 300 ends.

FIG. 4 is an exemplary flowchart 400 illustrating the operation of the wireless communication device 200 according to another embodiment. In step 410, the flowchart begins. For example, the wireless communication device 200 can be operating on the wideband code division multiple access network 102 and can receive a user input of an emergency call request on an input of the wireless communication device 200. In step 420, the wireless communication device 200 can send an initial direct transfer message with an emergency cause on an existing radio resource control connection. The wireless communication device 200 can send the initial direct transfer message with an emergency cause on an existing radio resource control connection on the wideband code division multiple access network 102. In step 430, the wireless communication device 200 can receive a connection release message with a call redirection cause. The connection release message can include inter-radio access technology redirection information. The wireless communication device 200 can avoid notifying a user of the wireless communication device 200 that that a call was released by the connection release message with the call redirection cause. In step 440, the wireless communication device 200 can synchronize to a designated global system for mobile communications cell. Synchronizing to a designated global system for mobile communications cell can include performing global system for mobile communications cell selection and camping on a global system for mobile communications cell. Performing global system for mobile communications cell selection can include collecting system information and reading system information on a selected global system for mobile communications cell. In step 450, the wireless communication device 200 can establish an emergency call on the global system for mobile communications cell. For example, the wireless communication device 200 can establish the emergency call by sending a channel request with an emergency cause to the global system for mobile communications network 104 after synchronizing to the designated global system for mobile communications cell. The wireless communication device 200 can then establish the emergency call on the global system for mobile communications network 104 after sending the channel request message with the emergency cause. In step 450, the flowchart 400 ends.

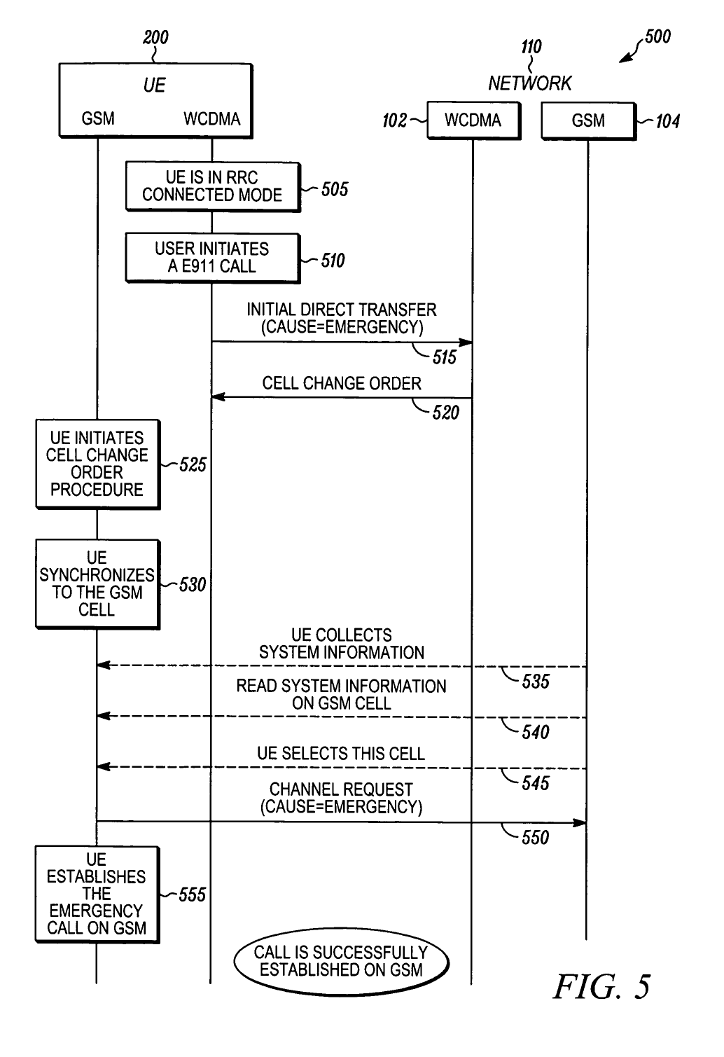

FIG. 5 is an exemplary signal diagram 500 illustrating signals in the system 100 according to one embodiment. The wireless communication device 200 can include global system for mobile communication (GSM) and wideband code division multiple access (WCDMA) circuitry or software in the controller 220. In step 505, the wireless communication device 200 can operate in radio resource control (RRC) connected mode on the WCDMA network 102. In step 510, a user of the wireless communication device 200 can initiate an emergency call. In step 515, the wireless communication device 200 can send an initial direct transfer (IDT) message with an emergency cause to the WCDMA network 102. In step 520, the WCDMA network 102 can send a cell change order to the wireless communication device 200 and the cell change order message can include a call redirection cause. In step 525, the wireless communication device 200 does not indicate the connection release or a call failure to the user and can initiate the cell change order procedure. In step 530, the wireless communication device 200 can synchronize to a GSM cell on the GSM network 104. In step 535, the wireless communication device 200 can collect system information. In step 540, the wireless communication device 200 can read system information on a selected GSM cell. In step 545, the wireless communication device 200 can select the GSM cell. In step 550, the wireless communication device 200 can send a channel request with an emergency cause to the GSM network 104. In step 555, the wireless communication device 200 can establish the emergency call on the GSM network 104.

Thus, the wireless communication device 200 can handle a cell change order when a circuit switch domain is active. As an example, when a user initiates an emergency call while the wireless communication device 200's RRC is in connected state, the wireless communication device 200 can use the existing signaling connection and send a “CM Service Request” through IDT message. A Universal Mobile Telecommunications System Terrestrial Radio Access Network (UTRAN) can know that the wireless communication device 200 is trying to establish an emergency call. The UTRAN can then send a Cell Change Order message which can include a call redirection cause to wireless communication device 200. At this point, the wireless communication device 200 can synchronize to the specified GSM carrier and establish the emergency call by sending a “Channel Request,” such as on RACH bursts, on the selected cell.

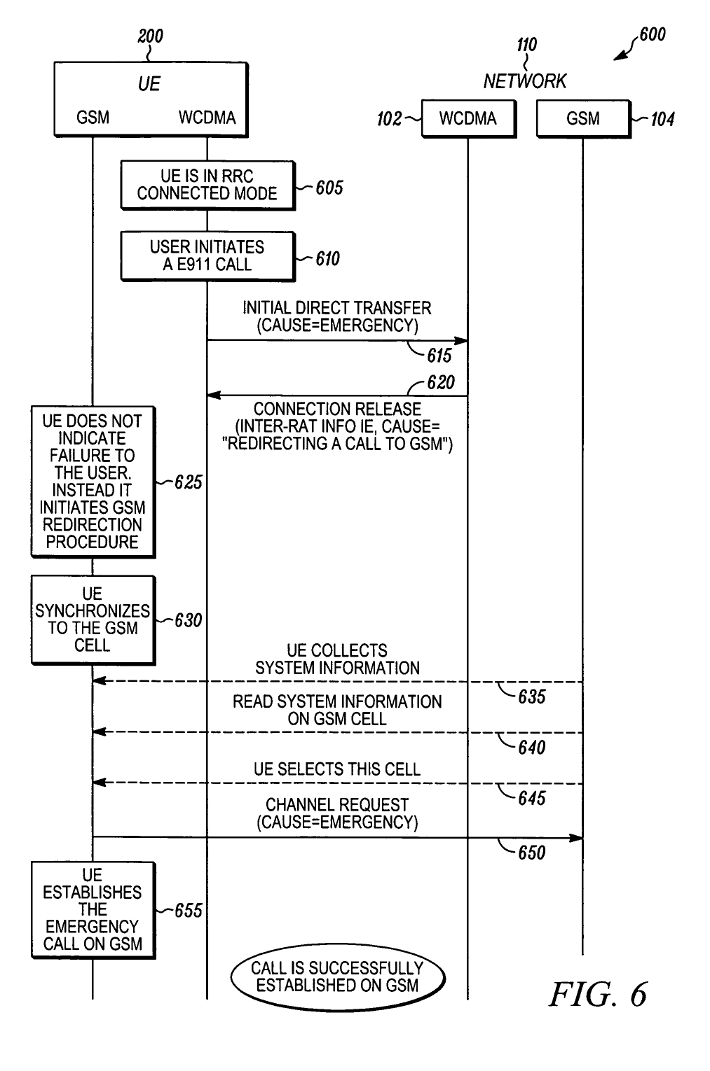

FIG. 6 is an exemplary signal diagram 600 illustrating signals in the system 100 according to another embodiment. In step 605, the wireless communication device 200 can operate in RRC connected mode on the WCDMA network 102. In step 610, a user of the wireless communication device 200 can initiate an emergency call. In step 615, the wireless communication device 200 can send an initial direct transfer (IDT) message with an emergency cause to the WCDMA network 102. In step 620, the WCDMA network 102 can send a connection release message including Inter-Radio Access Technology (Inter-RAT) information and with a cause of redirecting a call to GSM to the wireless communication device 200. In step 625, the wireless communication device 200 does not indicate the connection release or a call failure to the user and initiates a GSM redirection procedure. In step 630, the wireless communication device 200 can synchronize to a GSM cell on the GSM network 104. In step 635, the wireless communication device 200 can collect system information. In step 640, the wireless communication device 200 can read system information on a selected GSM cell. In step 645, the wireless communication device 200 can select the GSM cell. In step 650, the wireless communication device 200 can send a channel request with an emergency cause to the GSM network 104. In step 655, the wireless communication device 200 can establish the emergency call on the GSM network 104.

Thus, redirection information can be added to a RRC Connection Release message to direct a wireless communication device 200 to a certain RAT. This can be used to redirect the wireless communication device 200 to GSM after the network 110 receives an Initial Direct Transfer that includes a CM Service Request for an emergency call. The wireless communication device 200 can receive a Connection Release Message including a cause such as “redirecting a call to GSM.” The wireless communication device 200 does not inform the user that the call is released or failed. Therefore, if the wireless communication device 200 receives a Connection Release with this new cause, it can select a suitable GSM carrier and establish the emergency call automatically without notifying the user.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a wireless communication device comprising:
sending an initial direct transfer message with an emergency cause on an existing radio resource control connection;
receiving a cell change order;
synchronizing to a designated global system for mobile communications cell; and
establishing an emergency call on the global system for mobile communications cell.

2. The method according to claim 1, wherein sending an initial direct transfer message further comprises sending an initial direct transfer message with an emergency cause on an existing radio resource control connection on a wideband code division multiple access network.

3. The method according to claim 1, further comprising sending a channel request with an emergency cause to a global system for mobile communications network after synchronizing to the designated global system for mobile communications cell.

4. The method according to claim 1, further comprising maintaining the existing radio resource control connection while synchronizing to the designated global system for mobile communications cell.

5. The method according to claim 1, wherein synchronizing to a designated global system for mobile communications cell includes:
collecting system information; and
reading system information on the designated global system for mobile communications cell.

6. The method according to claim 1, further comprising operating on a wideband code division multiple access network.

7. The method according to claim 1, further comprising receiving a user input of an emergency call request on an input of the wireless communication device.

8. The method according to claim 1, wherein the cell change order includes a call redirection cause.

9. A wireless communication device comprising:
a user input configured to receive an emergency call request;
a transceiver configured to send an initial direct transfer message with an emergency cause on an existing radio resource control connection in response to the user input receiving the emergency call request; and
a controller coupled to the transceiver and the user input, the controller configured to control the operations of the wireless communication device, the controller including a cell change module configured to receive a cell change order, synchronize to a designated global system for mobile communications cell, and establish an emergency call on the global system for mobile communications cell.

10. The wireless communication device according to claim 9, wherein the transceiver is further configured to send the initial direct transfer message with an emergency cause on an existing radio resource control connection on a wideband code division multiple access network.

11. The wireless communication device according to claim 9, wherein the transceiver is further configured to send a channel request with an emergency cause to a global system for mobile communications network after synchronizing to the designated global system for mobile communications cell.

12. The wireless communication device according to claim 9, wherein the controller is further configured to maintain the existing radio resource control connection while the cell change module synchronizes to the designated global system for mobile communications cell.

13. The wireless communication device according to claim 9, wherein the cell change module is configured to synchronize to a designated global system for mobile communications cell by collecting system information and reading system information on the designated global system for mobile communications cell.

14. The wireless communication device according to claim 9, wherein the controller is configured to operate the wireless communication device on a wideband code division multiple access network.

15. A method in a wireless communication device comprising:
operating on a wideband code division multiple access network;
sending an initial direct transfer message with an emergency cause on an existing radio resource control connection on the wideband code division multiple access network;
receiving a cell change order;
synchronizing to a designated global system for mobile communications cell; and
establishing an emergency call on the global system for mobile communications cell.

16. The method according to claim 15, further comprising sending a channel request with an emergency cause to a global system for mobile communications network after synchronizing to the designated global system for mobile communications cell.

17. The method according to claim 15, further comprising maintaining the existing radio resource control connection while synchronizing to the designated global system for mobile communications cell.

18. The method according to claim 15, wherein synchronizing to a designated global system for mobile communications cell includes:
collecting system information; and
reading system information on the designated global system for mobile communications cell.

19. The method according to claim 15, further comprising receiving a user input of an emergency call request on an input of the wireless communication device.

20. The method according to claim 15, wherein the cell change order includes a call redirection cause.
